(19) United States
(12) Patent Application Publication
(10) Pub. No.: US 2007/0144340 A1
(43) Pub. Date: Jun. 28, 2007

(54) Adjustable Differential Flow Shuttle Valve Control System

(76) Inventor: Xiangwei Zeng, Chengdu, Sichuan (CN)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/611,630

(22) Filed: Dec. 15, 2006

(30) Foreign Application Priority Data
Dec. 16, 2005 (CN) 200510022315.7

(51) Int. Cl. F15B 13/04

(52) U.S. Cl. 91/444

(57) ABSTRACT

The present invention relates to an adjustable differential flow shuttle valve control system. The adjustable differential flow shuttle valve control system includes a direction control valve and a flow-rate control valve provided in medium inflow and outflow circuits of a working cylinder. The medium inflow and outflow circuits of the working cylinder (1) are connected with a two-position or three-position four-way valve (2). The medium inflow and outflow circuits of the working cylinder are provided with an adjustable differential flow shuttle valve (3).

The present application claims priority to Chinese Patent Application No. 200510022315.7, filed with the China Patent Office on Dec. 16, 2005.

### TECHNICAL FIELD

The invention relates to a velocity control adjustment system for a pressure cylinder, and more particularly, to a velocity control adjustment system for pressure cylinder by us of an adjustable differential flow shuttle valve.

### BACKGROUND OF THE INVENTION

Conventionally, a control circuit for a pressure cylinder includes a medium, a medium control circuit, a by-pass throttling control circuit, a series-parallel connection synchronizing control circuit. It is necessary for these circuits to be composed of multiple complex elements; therefore, the cost is high and the control precision is low.

In order to simplify the control circuit, the inventor has developed an adjustable differential shuttle valve, the construction of which has been given a detailed description in U.S. Pat. No. 4,872,475 granted to the present inventor. The entire contents of the patent are incorporated herein by reference. Referring to FIG. 12 and 13, the adjustable differential flow shuttle valve includes a regulating member 11, a shuttle core 12, a regulating member 13, a port 14, a housing 15, a shuttle chamber 16, a bypass passage 17, and a port 18. The work principle is as follows: the basic principle of the adjustable differential flow shuttle valve is: the flow rates both in the positive and reversal directions can be regulated and controlled by restricting “free shuttle”, which is balanceable, symmetric and suspended in the medium moving linearly along the axis of the pipeline, in place in the positive and reversal direction or applying energy to it. The differential characteristics after the out-of-balance is magnified or is directly used to control. The control is achieved with the own weight of the medium. Its characteristics are: the elements are balanceable, symmetric; the structural mechanics characteristics and fluidic characteristics are reasonable; the construction is simple and it saves energy. The “free shuttle” is fitted with the regulating member so as to construct a control element which integrates the sensitivity, control and execution together as whole and has a fast responsive speed. The regulating member 11 and 13 can be set to be adjusted with a constant ratio, manually adjusted, or steplessly adjusted in site, thereby realizing multiple functions.

### SUMMARY OF THE INVENTION

The object of the present invention is to provide a control system for a working cylinder, in which the construction is simple; the number of required elements is reduced; the cost is low and the control precision is high.

The object of the present invention is realized by the following:

The adjustable differential flow shuttle valve control system according to the present invention includes a direction control valve and a flow-rate control valve provided in medium inflow and outflow circuits of a working cylinder; the medium inflow and outflow circuits of the working cylinder are connected with a two-position or three-position four-way valve; the medium inflow and outflow circuits of the working cylinder are provided with an adjustable differential flow shuttle valve.

The said working cylinder is a single-cylinder or double cylinders or a single-acting cylinder or a double-acting cylinder.

The working cylinder is double cylinders connected in parallel with each other; pistons of the double cylinders are respectively positioned at both ends of the piston rod. The medium inflow circuit and the medium outflow circuit of the double cylinders are provided with a shared adjustable differential flow shuttle valve, or one of the medium inflow circuit and the medium outflow circuit of the double cylinders are provided with an adjustable differential flow shuttle valve and the other of the medium inflow circuit and the medium outflow circuit of the double cylinders is provided with a shuttle-type three-way diverting regulating valve. The adjustable differential flow shuttle valve is interconnected with the shuttle-type three-way diverting regulating valve.

The medium inflow circuit or the medium outflow circuit of the working cylinder is provided with two adjustable differential flow shuttle valves in series.

The working cylinder is single-cylinders connected in parallel with each other. The medium inflow circuit of each cylinder is provided with a separate adjustable differential flow shuttle.

The medium inflow circuit is connected with the medium outflow circuit via the adjustable differential flow shuttle valve.

The driving apparatuses of the adjustable differential flow shuttle valve, the shuttle-type three-way diverting regulating valve or/and the four-way valve are connected with the control system.

The present invention has a simple construction, are easy to manufacture, and has a low cost. The adjustable differential flow shuttle valve is used to control the flow rate and impedance at the inlet and outlet of the working cylinder; therefore, the circuit can be simplified and the precision can be improved. The balance valve is not required when double cylinders are in operation, and the own energy of the fluidic medium can also be utilized to operate in its own way the opening and closing of the valve driven by the working cylinder. It can be used to control a ball valve, a butterfly valve, a plate valve, and it can be widely applied to the pipeline systems for natural gas, petroleum, liquefied gas, chemical petroleum, chemical industry, water & electricity, and environment protection. It has the function of connecting and cutting off the pipeline transportation medium. The control apparatus of the present invention has the following advantages:

Safe and reliable: the combination of various shuttle valves and control systems can ensure the rapid adjustment and control of the pressure, flow rate, air discharge, air addition, explosion, water stroke. When the failure occurs, the emergent cut-off can be done by means of transporting medium itself.

Economical and utilizable: additional operational energies are not required; expensive and complex control (for example, SCADA) systems are not required; the communication networks are no required; the investment is small; the cost is low; it is easy to manufacture; it is immune to the interference and not influenced by electronic wars.

Strong suitability: it is suitable for various severe environments, such as deserts, underground, water, forests etc.; it is suitable for systems transmitting high temperature, high pressure, corrosive, poisonous, radioactive and noxious mediums.

Good compatibility: the shuttle valve can be used independently in any technical systems of the prior art; it can realize stepless adjustment in site (no requiring external power source) by using original communication systems and servo systems; it can also be integrated with satellite system (VSAT) and SCADA, etc. into modern integrated control system.

### DESCRIPTION OF THE DRAWINGS

FIG. 1 is an elementary diagram of an inflow throttling and outflow diverting control circuit according to the first embodiment of the present invention;

FIG. 2 is an elementary diagram of an inflow throttling control circuit of the prior art;

FIG. 3 is an elementary diagram of an outflow throttling control circuit of the prior art;

FIG. 4 is an elementary diagram of inflow and outflow throttling control circuits according to the second embodiment of the present invention;

FIG. 5 is an elementary diagram of inflow, outflow throttling and diverting control circuits according to the third embodiment of the present invention;

FIG. 6 is an elementary diagram of an inflow diverting and outflow throttling control circuit for the cylinder positioned vertically according to the fourth embodiment of the present invention;

FIG. 7 is an elementary diagram of an outflow throttling control circuit for the cylinder provided with springs according to the fifth embodiment of the present invention;

FIG. 8 is an elementary diagram of a control circuit for a double-acting cylinder according to the sixth embodiment of the present invention;

FIG. 9 is an elementary diagram of an inflow and outflow throttling control circuit for cylinders positioned vertically, which are connected in parallel with each other, according to the seventh embodiment of the present invention;

FIG. 10 is an elementary diagram of a bridge-type throttling circuit of the prior art;

FIG. 11 is an elementary diagram of an inflow and outflow throttling control circuit for the single-acting cylinders, which are in parallel with each other, according to the eighth embodiment of the present invention;

FIG. 12 is a working principle diagram of an adjustable differential flow shuttle valve used in the present invention;

FIG. 13 is a structural diagram of a three-way shuttle-type diverting regulating valve used in the present invention.

### DETAILED DESCRIPTION OF PREFERRED EMBODIMENT(S)

### Embodiment 1

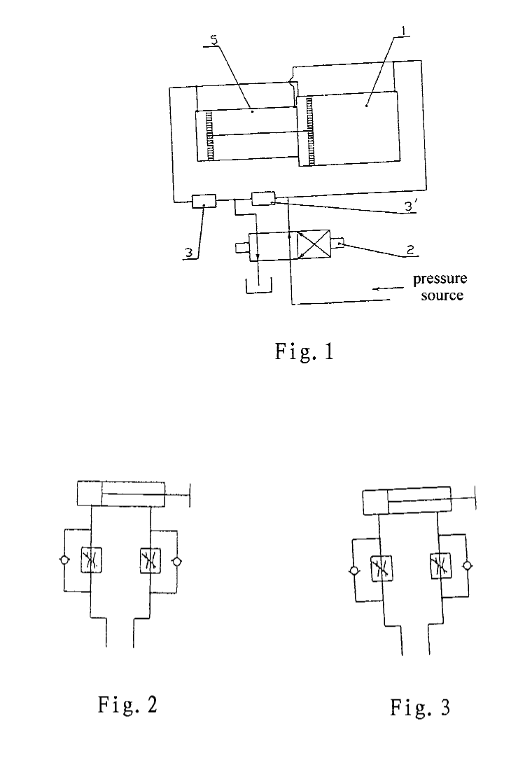

The first embodiment according to the present invention will be described below with reference to FIG. 1. As shown in FIG. 1, double working cylinders 1 have a common piston rod 5. The piston is positioned at the both ends of the piston rod 5. One end of the double cylinders is connected with one end of the first adjustable differential flow shuttle valve 3 and the medium port of the first working position of a two-position four-way diverter valve 2. The medium is flowed into the diverter valve from the pressure source. The other end of the double cylinders is connected with one end of the second adjustable differential flow shuttle valve 3′. The other ends of the first and second adjustable differential flow shuttle valve are connected with each other, and are connected with another medium port of the first working position of a two-position four-way diverter valve.

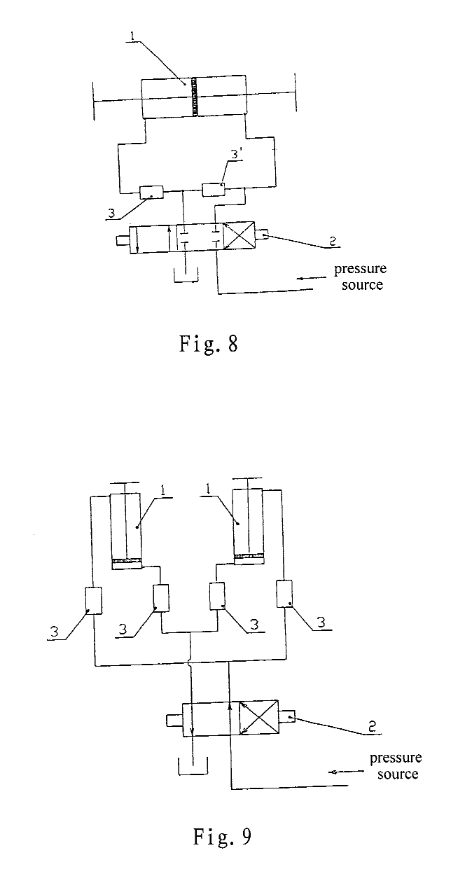

During the operation, at the first working position of the two-position four-way diverter 2, that is, at the working position as shown in FIG. 1., the medium is flowed into right end of the double cylinders 1 via the diverter valve 2 from the pressure source and pushes the piston towards the left side. At this time, the shuttle core of the second adjustable differential flow shuttle valve 3′ is moved to the left side of FIG. 1 under the pressure of the medium (referring to FIG. 9), thereby implementing blocking or throttling when necessary, which can be achieved by adjusting the regulating member 11 of the shuttle valve, that is, the diverting flow rate of the medium can be controlled by adjusting the regulating member 11 of the shuttle valve, whereby controlling the speed of the piston moving in the left direction. At this time, it can be readily understood from FIG. 8 that the shuttle valve on the left side of FIG. 8 has the function of throttling the return oil of the working cylinders.

When the two-position four-way diverter valve 2 is in the second working position, the medium from the pressure source is flowed into the other end of the working cylinders through the diverter valve and the first adjustable differential flow shuttle valve 3. In the same way, at this time, the first shuttle valve 3 has the function of inflow throttling and the second shuttle valve 3′ can has the function of blocking (one-direction valve) or diverting when necessary.

With the construction as described above, the shuttle valve 3 (on the right side) can act as a balance valve, and different diverting flow can be achieved by adjusting the regulating member 11 or 13 of the said shuttle valve, which otherwise would not be achieved by using the conventional balance valve merely having switching functions.

### Embodiment 2

First of all, the inflow throttling circuit and the outflow throttling circuit of the prior art will be described in order to have a better understanding of the present invention. As shown in FIG. 2, FIG. 2 shows a control circuit of the prior art having the function of inflow throttling, wherein the first end and the second end of the working cylinder are respectively connected with a throttling valve 3. Moreover, across each throttling valve, a one-way valve 4 is connected, and the one-way valve is arranged to be block in the direction of the medium flowing into the working cylinder, so that the medium must flow into the working cylinder through the throttling valve 3, thereby realizing the function of inlet throttling.

FIG. 3 shows a control circuit of the prior art having the function of outflow throttling. This control circuit has a substantially same construction as the above-described control circuit having the function of inflow throttling. The difference therebetween lies in that the one-direction valve of the outflow throttling control circuit is arranged to be block in the direction of the medium flowing out of the working cylinder, so that the medium has to return to the oil tank via the throttling valve 3.

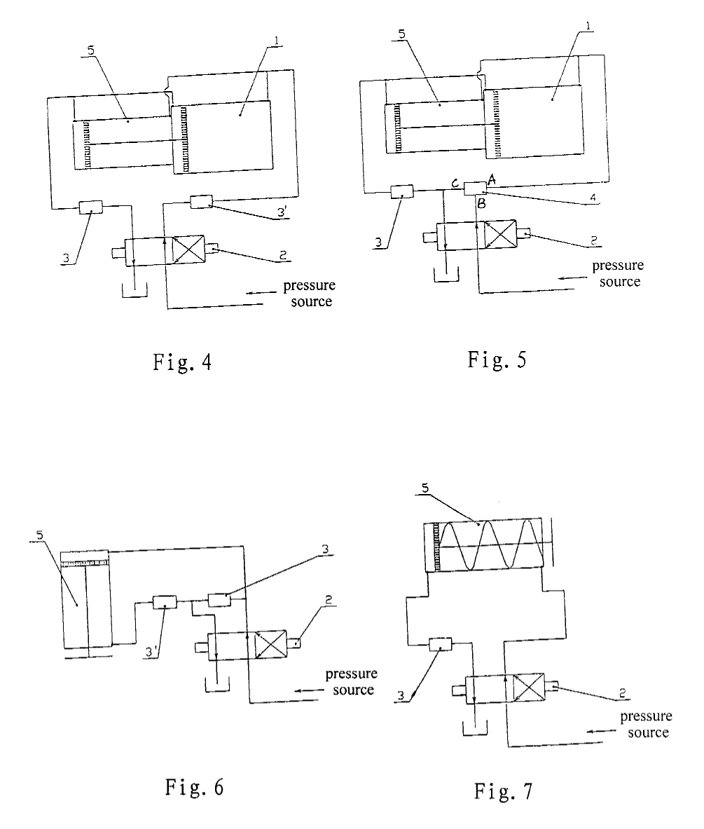

Hereinafter, the inflow and outflow control circuit according to the present invention will be described with reference to FIG. 4. As shown in FIG. 4, the double working cylinders 1 have the same construction as the one in the first embodiment. One end of the double working cylinders is connected with one end of the first adjustable differential flow shuttle valve 3 and the other end of the first adjustable differential flow shuttle valve 3 is connected with the medium outlet of the first working position of a two-position four-way diverter valve 2; the second end of the double cylinders is connected with one end of the second adjustable differential flow shuttle valve 3′ and the other end of the second adjustable differential flow shuttle valve 3′ is connected with the medium inlet of the first working position of the two-position four-way valve 2.

With the above-described construction, the function of inflow and outflow throttling of the left and right cylinders can be realized. Specifically, in the first working position as shown in the FIG. 4, the medium from the pressure source reaches the right end of the working cylinder 1 via the diverter valve and the second adjustable differential flow shuttle valve 3′. At this time, the shuttle core of the second adjustable differential flow shuttle 3′ moves in the right direction under the pressure of the medium, thereby having the function of inflow throttling. At the same time, the medium returning from the left end of the working cylinder 1 passes through the first adjustable differential flow shuttle valve 3. In the same way, the shuttle core of the first adjustable differential flow shuttle valve 3 moves in the right direction under the pressure of the return oil, thereby having the function of outflow throttling.

With the construction according to the second embodiment, the function of inflow throttling and outflow throttling can be realized by only using two adjustable differential flow shuttle valves. Compared the construction according to the second embodiment with the construction of the prior art, It can be seen that the construction according to the second embodiment obviously makes the numbers of parts reduced and simplifies the circuit structure.

### Embodiment 3

The control circuit according to the third embodiment of the present invention will be described below with reference to FIG. 5. As shown in FIG. 5, a working cylinder 1 has the same construction as that in the first and second embodiments described above. The right end of the working cylinder is connected with the port A of a shuttle-type three-way diverting regulating valve 4 (referring to FIG. 9). The port B of the three-way diverting regulating valve is connected with the medium outlet end of the first working position of a two-position four-way diverter valve 2. The port C of the diverting regulating valve is connected with one end of an adjustable differential flow shuttle valve 3 and the medium outlet end of the first working position of the two-position four-way diverter valve 2. The other end of the adjustable differential flow shuttle valve 3 is connected the left end of the working cylinder 1.

During the operation, when the diverter valve 2 is in the first working position as shown in FIG. 5, the medium from the pressure source enters the port B of the three-way diverting regulating valve 4 via the diverter valve 2. It can be appreciated from FIG. 9 that the shuttle core 12 moves in the left direction under the pressure of the medium. It can be appreciated from the description of the first embodiment, at this time, the port B to the port A of the three-way diverting regulating valve has the function of inflow throttling, and the port B to the port C has the function of diverting. In the same way, the adjustable differential flow shuttle valve 3 has the function of outflow throttling.

When the diverted valve 2 moves from the first working position as shown in FIG. 5 to the second working position, the medium from the pressure source is introduced into the working cylinder via the adjustable differential flow shuttle valve 3. At this time, the adjustable differential flow shuttle valve 3 has the function of inflow throttling. However, in the three-way diverting regulating valve, the port B to the port A has the function of diverting, and the port A to the port B has the function of outflow throttling.

With the construction according to the present embodiment, the function of the inflow, outflow throttling and diverting can be realized in the case where only one adjustable differential flow shuttle valve and one three-way diverting regulating valve are used.

### Embodiment 4

The fourth embodiment according to the present invention will be described below with reference to FIG. 6. As shown in FIG. 6, the working cylinder is a vertically-positioned cylinder, for example, a working cylinder used in lifting equipments. The upper end of the working cylinder is connected with one end of the first adjustable differential flow shuttle valve 3 and the medium outlet end of the first working position of a two-position four-way diverted valve 2. The lower end of the working cylinder 1 is connected with one end of the second adjustable differential flow shuttle valve 3′. The other ends of the first and second adjustable differential flow shuttle valves are connected to each other and connected with the medium inlet end of the first working position of the two-position four-way diverter valve 2.

As shown in FIG. 6, the working cylinder is a vertically-positioned cylinder. For example, the object to be lifted is connected to the cylinder of the working cylinder. In the state where the working cylinder does not work, the piston is in the uppermost position in the cylindrical portion under the gravity of the object therein. In the operation, as shown in FIG. 6, the diverter valve 2 is in the first working position and the medium from the pressure source enters the first end of the working cylinder 1 via the diverter valve 2, pushing the piston to move downwards and thereby pushing the object therein upwards. At this time, as described in the first embodiment, the first adjustable differential flow shuttle valve 3 has the function of diverting. The diverting amount can be controlled by adjusting the regulating member 11 of the shuttle valve 3, thereby controlling the lifting velocity of the working cylinder,

### Embodiment 5

The fifth embodiment according to the present invention will be described below with reference to FIG. 7. As shown in FIG. 7, a single-acting cylinder 1 is connected with a two-position four-way valve 2, the circuit of which is connected with an adjustable differential flow shuttle valve 3. It can be seen that a biasing member such as a spring is provided in the single-acting cylinder. When the circuit is not in operation, the piston is in the leftmost side of the acting cylinder with the action of the spring. In the position as described in FIG. 7, the adjustable differential flow shuttle valve 3 has the function of outflow throttling, thereby controlling the returning velocity of the piston.

### Embodiment 6

The sixth embodiment according to the present invention will described below with reference to FIG. 8. As described in FIG. 8, a double-acting cylinder 1 is connected with a three-position four-way valve 2, one circuit of which is connected with an adjustable differential flow shuttle valve 3, and the adjustable differential flow shuttle valve 3 is connected with another circuit via another adjustable differential flow shuttle valve 3′.

When the three-position four-way valve is in the first and third position, i.e. in the working position of the left and right side of FIG. 8, the circuit works in the same way as described in the first embodiment according the present invention, thereby the detailed description thereof omitted.

When the three-position four-way valve is in the intermediate position as described in FIG. 8, two of adjustable differential flow shuttle valves 3 has the function of a balance valve, thereby enabling the piston to stop at any position.

### Embodiment 7

The seventh embodiment 7 according to the present invention will be described below with reference to FIG. 9. As described in FIG. 9, two single-acting cylinders are connected in parallel with a two-position four-way valve, and each of four circuits has an adjustable differential flow shuttle valve 3.

Two single-acting cylinders both are vertically-positioned cylinders, the inlet and outlet circuit of which are respectively provided with an adjustable differential flow shuttle valve 3, thereby implementing the function of inflow and outflow throttling for two acting cylinders. Referring to the embodiment described above, the working principle of the present embodiment can be readily understood by those skilled in the art and the description thereof is omitted.

### Embodiment 8

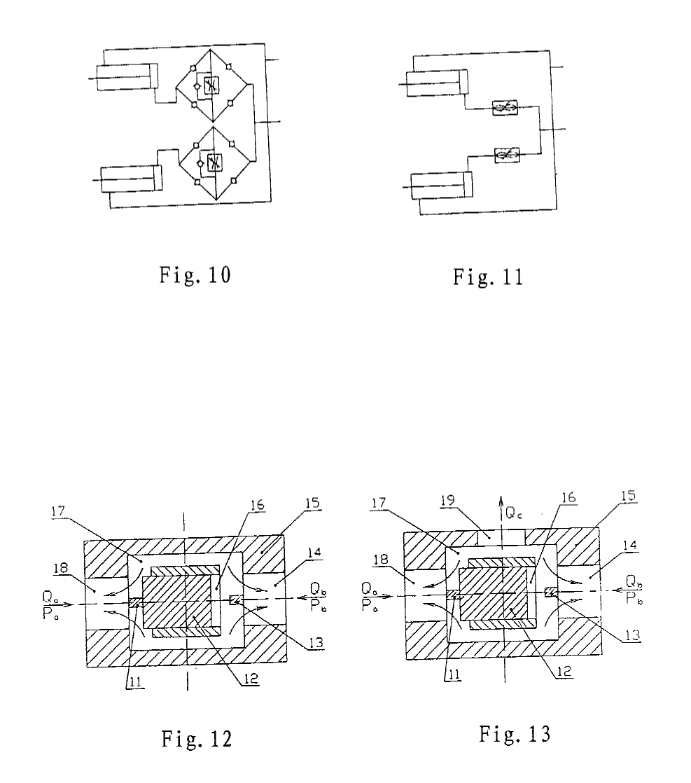

The eighth embodiment according to the present invention will be described below with reference to FIGS. 10 and 11, wherein FIG. 10 shows a bridge-type one-side inflow and outflow control circuit of the prior art and FIG. 11 shows a control circuit according the eighth embodiment of the present invention.

As described in FIG. 10, the inflow and outflow control circuit includes two single-acting cylinder circuits which are in parallel with each other. In each single-acting cylinder circuit, one end of the acting cylinder is connected with the bridge-type circuit, thereby realizing inlet and outlet throttling of the acting cylinder. The bridge-type circuit is composed of five one-way valves and one throttling valve, this circuit is widely used, e.g. in mill machines. Since the circuit is known in the art, the description thereof is omitted.

As described in FIG. 11, in the eighth embodiment according to the present invention, the same function can realized with use of the adjustable differential flow shuttle valve instead of the bridge-type circuit shown in FIG. 10. Since the operational process of the present embodiment can be easily understood from the above description, the detailed description thereof is omitted.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An adjustable differential flow shuttle valve control system including medium inflow and outflow circuits of a working cylinder, and a diverter valve, characterized in that the medium inflow and outflow circuits of the working cylinder (1) are connected with the said diverter valve (2); an adjustable differential flow shuttle valve (3) is provided in the medium inflow circuit and/or the medium outflow circuit, which connects the working cylinder with the said diverter valve.

2. The adjustable differential flow shuttle valve control system according to claim 1, characterized in that said working cylinder (1) is a single-cylinder or double cylinders or a single-acting cylinder or a double-acting cylinder.

3. The adjustable differential flow shuttle valve control system according to claim 1, characterized in that the working cylinder (1) is double cylinders connected in parallel with each other; pistons of the double cylinders are respectively positioned at both ends of the piston rod (5); the medium inflow circuit and the medium outflow circuit of the double cylinders are provided with a shared adjustable differential flow shuttle valve (3) having the function of diverting.

4. The adjustable differential flow shuttle valve control system according to claim 1, characterized in that the working cylinder (1) is double cylinders connected in parallel with each other; pistons of the double cylinders are respectively positioned at both ends of the piston rod (5); one of the medium inflow circuit and the medium outflow circuit of the double cylinders are provided with an adjustable differential flow shuttle valve (3) and the other of the medium inflow circuit and the medium outflow circuit of the double cylinders is provided with a shuttle-type three-way diverting regulating valve (4); the adjustable differential flow shuttle valve (3) is interconnected with the shuttle-type three-way diverting regulating valve (4).

5. The adjustable differential flow shuttle valve control system according to claim 1 or 2, characterized in that the medium inflow circuit or the medium outflow circuit of the working cylinder (1) is provided with two adjustable differential flow shuttle valves in series.

6. The adjustable differential flow shuttle valve control system according to claim 1 or 2, characterized in that the working cylinder (1) is single-cylinders connected in parallel with each other, the medium inflow circuit of each cylinder is provided with a separate adjustable differential flow shuttle (3).

7. The adjustable differential flow shuttle valve control system according to claim 1, characterized in that the medium inflow circuit is connected with the medium outflow circuit via the adjustable differential flow shuttle valve (3).

8. The adjustable differential flow shuttle valve control system according to claim 1, characterized in that the working cylinder is single-acting cylinders connected in parallel with each other, the medium inflow circuit or the medium outflow circuit of each of the said working cylinders is respectively provided with the adjustable differential flow shuttle valve (3).

9. The adjustable differential flow shuttle valve control system according to claim 1 or 3, characterized in that the driving apparatuses of the said adjustable differential shuttle valve (3), the shuttle-type three-way diverting regulating valve (4) or/and the diverter valve (2) are connected with the control system.
